(19) United States
(12) Patent Application Publication
(10) Pub. No.: US 2023/0132793 A1
(43) Pub. Date: May 4, 2023

(54) Use of polyamide 6

(71) Applicant: LANXESS Performance Materials GmbH, Cologne (DE)

(72) Inventors: Claudia Schmid-Daehling, Dormagen (DE); Jochen Endtner, Cologne (DE); Matthias Bienmueller, Krefeld (DE)

(73) Assignee: LANXESS Performance Materials GmbH, Cologne (DE)

(21) Appl. No.: 17/979,284

(22) Filed: Nov. 2, 2022

(30) Foreign Application Priority Data
Nov. 4, 2021 (EP) 21206388.7

(51) Int. Cl. C08L 67/03; C08K 7/14; B29C 45/00; C08L 33/24

(52) U.S. Cl. CPC C08L 67/03; C08K 7/14; B29C 45/0001; B29C 45/0005; C08L 33/24; C08L 2203/20; B29K 2023/06; B29K 2105/12

(57) ABSTRACT

The invention relates to the use of polyamide 6 for reduction of the melt viscosity, to be determined at 260° C. to ISO 11443, and/or of the fill pressure, to be determined according to EN ISO 294-1, of compositions and moulding compounds in which there are 10 to 115 parts by mass of glass fibres per 100 parts by mass of poly-C₁-C₆-alkylene terephthalate.

The invention relates to the use of polyamide 6 for reduction of the melt viscosity, to be determined at 260° C. to ISO 11443, and/or of the fill pressure of compositions and moulding compounds in which there are 10 to 115 parts by mass of glass fibres per 100 parts by mass of poly-C₁-C₆-alkylene terephthalate.

### PRIOR ART

As well as mechanical properties such as elongation at break, tensile strength or tensile modulus, recent research has focused particularly on the processibility of polyalkylene terephthalate-based compositions for production of articles of manufacture for electromobility. Particularly for processing by injection moulding, the aim here is low shear viscosities of the moulding compounds to be processed and low fill pressure in the filling of cavities in the injection mould.

DE 10 2004 027 872 A1 discloses a method of lowering the melt viscosity of compositions containing A) 99.9 to 10 parts by weight of at least one semi-crystalline thermoplastic polyamide, B) 0.1 to 20 parts by weight of at least one copolymer of at least one α-olefin with at least one methacrylic ester or acrylic ester of an aliphatic alcohol, C) 0 to 70 parts by weight of at least one filler or reinforcer, D) 0 to 30 parts by weight of at least one flame-retardant additive, and E) 0 to 60 parts by weight of at least one elastomer modifier, F) 0% to 10% by weight of other customary additives, in which the copolymer B) does not contain any further reactive functional groups and the MFI of the copolymer B) does not go below 100 g/10 min.

EP 1 790 692 A2 relates to moulding compounds based on polyesters and solves the lowering of the viscosity of polyester compositions, with lowering of the fill pressure of moulding compounds based thereon.

The person skilled in the art knows from WO 2005/121245 A1 that mixtures of thermoplastic polyesters with copolymers of α-olefins with (meth)acrylic esters of aliphatic alcohols that have an MFI that does not go below 100 g/10 min lead to lowering of the melt viscosity of the moulding compounds to be produced therefrom and, compared to moulding compounds without copolymer, do not have any losses but in some cases even have improvements in properties such as impact resistance, elongation at break and hydrolysis stability. The examples in WO 2005/121245 A1 additionally show that the copolymer reduces the fill pressure in injection moulding to be determined both according to ISO 527 and according to ISO 178.

Proceeding from this prior art, the problem addressed by the present invention was that of reducing the shear viscosity of glass fibre-reinforced poly-C₁-C₆-alkylene terephthalate compositions and the fill pressure of glass fibre-reinforced poly-C₁-C₆-alkylene terephthalate compositions or moulding compounds based thereon in injection moulding, without obtaining losses in heat distortion resistance and without obtaining drawbacks in terms of mechanical indices, especially tensile modulus, tensile strength and elongation at break, compared to the values of WO 2005/121245 A1. What would be disadvantageous for the purposes of the present invention would be a decrease in the heat distortion resistance of moulding compounds to be processed below 180° C., or differences in all three mechanical properties of tensile modulus, tensile strength and elongation at break of more than 10% compared to compositions without the polyamide 6 to be used according to the present invention.

This is because it has been found that, surprisingly, the mere addition of polyamide 6 can reduce both the melt viscosity of glass fibre-reinforced poly-C₁-C₆-alkylene terephthalate moulding compounds, especially polybutylene terephthalate-based moulding compounds, and the fill pressure in the use of glass fibre-reinforced poly-C₁-C₆-alkylene terephthalate moulding compounds in injection moulding. The mere addition of polyamide 6 can reduce the fill pressure for the use of glass fibre-reinforced poly-C₁-C₆-alkylene terephthalate moulding compounds in injection moulding compared to the same glass fibre-reinforced composition in the presence of an ethylene-butyl acrylate copolymer but without polyamide 6 by another more than 10% compared to the results of WO 2005/121245 A1.

Melt volume flow rate (MVR) is determined in WO 2005/121245 A1 according to ISO 1133 by means of a capillary rheometer. The subject of the studies in respect of the present invention is the melt viscosity, which, in the context of the present invention, is determined at 260° C. to ISO 11443 at the respectively specified shear rate.

For determination of the fill pressure according to EN ISO 294-1 for the moulding compounds based on the compositions according to the invention that are to be processed by injection moulding, in the context of the present invention, a dumbbell specimen having a geometry according to ISO 527-2/type 1A is injection-moulded, and the pressure required in an injection moulding machine is recorded. The melt temperature is set to 260° C. and the mould temperature to 80° C.

Tensile modulus, tensile strength and elongation at break are measured in the context of the present invention according to ISO 527. Modulus of elasticity, also called E modulus, tensile modulus, coefficient of elasticity, modulus of elongation or Young's modulus, is a material index from materials engineering that describes the proportional correlation between stress and strain in the deformation of a solid body, given linear-elastic behaviour. Elongation at break is a specific material index that indicates the deformation capacity of a material in the plastic region (also called ductility) before fracture.

### SUMMARY OF THE INVENTION

The present invention provides for the use of polyamide 6 for reduction of the melt viscosity, to be determined at 260° C. to ISO 11443, and/or of the fill pressure, to be determined according to EN ISO 294-1, of compositions and moulding compounds in which there are 10 to 115 parts by mass of glass fibres per 100 parts by mass of poly-C₁-C₆-alkylene terephthalate, preferably polyethylene terephthalate (PET) or polybutylene terephthalate (PBT), especially polybutylene terephthalate.

It should be noted for the avoidance of doubt that the scope of the present invention encompasses all below-referenced definitions and parameters referred to in general terms or within preferred ranges in any desired combinations. This applies both in relation to the compositions, moulding compounds and articles of manufacture claimed and to methods and uses according to the invention. Citations of standards refer to the version valid at the filing date of this invention.

“Alkyl” in the context of the present invention refers to a straight-chain or branched saturated hydrocarbon group. A corresponding definition applies to alkylene. The invention discusses C₁-C₆-polyalkylene terephthalates. Preferred alkylene groups are methylene (Me), ethylene (Et), propylene, especially n-propylene and isopropylene, butylene, especially n-butylene, isobutylene, sec-butylene, tert-butylene, pentylene groups, especially n-pentylene, isopentylene, neopentylene, and isomers of the hexylenes that are known to the person skilled in the art.

The invention additionally relates to a method of reducing the melt viscosity, to be determined at 260° C. to ISO 11443, and/or of the fill pressure, to be determined according to EN ISO 294-1, of compositions and moulding compounds in which there are 10 to 115 parts by mass of glass fibres per 100 parts by mass of poly-C₁-C₆-alkylene terephthalate, preferably polyethylene terephthalate (PET) or polybutylene terephthalate (PBT), especially polybutylene terephthalate, by addition of polyamide 6, preferably by addition of polyamide 6 in amounts in the range of 0.5 to 15 parts by mass.

Finally, the invention also provides compositions, moulding compounds and articles of manufacture comprising, per

A) 100 parts by mass of poly-C₁-C₆-alkylene terephthalate, preferably polyethylene terephthalate (PET) or polybutylene terephthalate (PBT), especially polybutylene terephthalate,

B) 10 to 115 parts by mass of glass fibres,

C) 0.5 to 15 parts by mass of polyamide 6, and

D) 0.5 to 30 parts by mass of at least one copolymer of at least one α-olefin and at least one methacrylic ester or acrylic ester of an aliphatic alcohol.

Preferred Embodiments of the Invention

The present invention preferably relates to the use of polyamide 6 for reduction of the melt viscosity, to be determined at 260° C. to ISO 11443, and/or of the fill pressure, to be determined according to EN ISO 294-1, of compositions and moulding compounds in which there are 10 to 115 parts by mass of glass fibres and 0.5 to 30 parts by mass of at least one copolymer of at least one α-olefin and at least one methacrylic ester or acrylic ester of an aliphatic alcohol per 100 parts by mass of poly-C₁-C₆-alkylene terephthalate, preferably polyethylene terephthalate (PET) or polybutylene terephthalate (PBT), especially polybutylene terephthalate.

The present invention more preferably relates to the use of polyamide 6 for reduction of the melt viscosity, to be determined at 260° C. to ISO 11443, and/or of the fill pressure, to be determined according to EN ISO 294-1, of compositions and moulding compounds in which there are 10 to 115 parts by mass of glass fibres and 0.5 to 30 parts by mass of at least one copolymer of at least one α-olefin and at least one methacrylic ester or acrylic ester of an aliphatic alcohol per 100 parts by mass of poly-C₁-C₆-alkylene terephthalate, preferably polyethylene terephthalate (PET) or polybutylene terephthalate (PBT), especially polybutylene terephthalate, where the amount of polyamide 6 used is 0.5 to 15 parts by mass.

The present invention preferably relates to a method of reducing the melt viscosity, to be determined at 260° C. to ISO 11443, and/or of the fill pressure, to be determined according to EN ISO 294-1, of compositions and moulding compounds in which there are 10 to 115 parts by mass of glass fibres and 0.5 to 30 parts by mass of at least one copolymer of at least one α-olefin and at least one methacrylic ester or acrylic ester of an aliphatic alcohol per 100 parts by mass of poly-C₁-C₆-alkylene terephthalate, preferably polyethylene terephthalate (PET) or polybutylene terephthalate (PBT), especially polybutylene terephthalate, by adding polyamide 6, preferably by adding polyamide 6 in amounts in the range of 0.5 to 15 parts by mass.

In a further-preferred embodiment, the compositions, moulding compounds and articles of manufacture according to the invention comprise, in addition to components A) to D), also E) at least one further additive other than components B), C) and D), preferably in amounts in the range of 0.01 to 80 parts by mass, based on 100 parts by mass of component A).

The compositions according to the invention, also generally referred to in the plastics industry as moulding compounds, are obtained on processing of the individual components, preferably as pelletized material, in the form of extrudates or as powder. Moulding compounds according to the invention are prepared by mixing the compositions according to the invention in at least one mixing apparatus, preferably in a compounder, more preferably in a corotating twin-screw extruder. The operation of mixing the individual components to produce compositions according to the invention in the form of powders, pellets or in extrudate form is also referred to as compounding in the plastics industry. This affords, as intermediates, moulding compounds based on the compositions of the invention. These moulding compounds—also referred to as thermoplastic moulding compounds—may either consist exclusively of components A), B), C) and D), or else may comprise at least a further component E) in addition to these components. In a further step, the moulding compounds of the invention are then subjected as matrix material to an injection moulding or extrusion operation, preferably an injection moulding operation, in order to produce articles of manufacture according to the invention therefrom.

Poly-C₁-C₆-Alkylene Terephthalates (Component A)

Poly-C₁-C₆-alkylene terephthalates may be prepared by various methods, may be synthesized from different starting materials, and in the specific application scenario may be modified, alone or in combination, with processing aids, stabilizers, polymeric alloying components (e.g. elastomers) or else reinforcing materials (such as mineral fillers or glass fibres, for example) and optionally further additives, to give materials having tailored combinations of properties. Also suitable are blends comprising proportions of other polymers, in which case one or more compatibilizers may be used. The properties of the polymers can be improved if required by addition of elastomers.

Preferred poly-C₁-C₆-alkylene terephthalates can be prepared by known methods from terephthalic acid or reactive derivatives thereof and aliphatic or cycloaliphatic diols having 2 to 10 carbon atoms (Kunststoff-Handbuch [Plastics Handbook], vol. VIII, p. 695 ﬀ, Karl Hanser Verlag, Munich 1973).

Preferred poly-C₁-C₆-alkylene terephthalates contain at least 80 mol %, preferably at least 90 mol %, based on the dicarboxylic acid, of terephthalic acid radicals and at least 80 mol %, preferably at least 90 mol %, based on the diol component, of cyclohexane-1,4-dimethanol and/or ethylene glycol and/or propane-1,3-diol (in the case of polypropylene terephthalate) and/or butane-1,4-diol radicals.

Preferred poly-C₁-C₆-alkylene terephthalates, as well as terephthalic acid radicals, may contain up to 20 mol % of radicals of other aromatic dicarboxylic acids having 8 to 14 carbon atoms or radicals of aliphatic dicarboxylic acids having 4 to 12 carbon atoms, more particularly radicals of phthalic acid, isophthalic acid, naphthalene-2,6-dicarboxylic acid, 4,4′-biphenyldicarboxylic acid, succinic acid, adipic acid, sebacic acid, azelaic acid, cyclohexanediacetic acid, cyclohexanedicarboxylic acid.

Preferred poly-C₁-C₆-alkylene terephthalates, as well as cyclohexane-1,4-dimethanol and/or ethylene glycol and/or propane-1,3-diol and/or butane-1,4-diol, may contain up to 20 mol % of other aliphatic diols having 3 to 12 carbon atoms or up to 20 mol % of cycloaliphatic diols having 6 to 21 carbon atoms, preferably radicals of propane-1,3-diol, 2-ethylpropane-1,3-diol, neopentyl glycol, pentane-1,5-diol, hexane-1,6-diol, 3-methylpentane-2,4-diol, 2-methylpentane-2,4-diol, 2,2,4-trimethylpentane-1,3-diol, 2,2,4-trimethylpentane-1,5-diol, 2-ethylhexane-1,3-diol, 2,2-diethylpropane-1,3-diol, hexane-2,5-diol, 1,4-di(β-hydroxyethoxy)benzene, 2,2-bis(4-hydroxycyclohexyl)propane, 2,4-dihydroxy-1,1,3,3-tetramethylcyclobutane, 2,2-bis(3-β-hydroxyethoxyphenyl)propane and 2,2-bis(4-hydroxypropoxyphenyl)propane.

Particularly preferred poly-C₁-C₆-alkylene terephthalates are prepared solely from terephthalic acid and reactive derivatives thereof, especially dialkyl esters thereof, and cyclohexane-1,4-dimethanol and/or ethylene glycol and/or propane-1,3-diol and/or butane-1,4-diol; especially preferred are polycyclohexane-1,4-dimethanol terephthalate, polyethylene terephthalate and polybutylene terephthalate and mixtures thereof.

The poly-C₁-C₆-alkylene terephthalates may also be recyclates. Recyclates are generally understood to mean:
1) what is called post-industrial recyclate (also called pre-consumer recyclate): this comprises production wastes from polycondensation, from compounding (e.g. off-spec material) or from processing, for example sprues in injection moulding, start-up material in injection moulding or extrusion, or edges cut from extruded sheets or films.
2) post-consumer recyclate: this comprises plastics articles which are collected and processed after use by the end user. By far the dominant articles in terms of volume are blow-moulded PET bottles for mineral water, soft drinks and juices.

PET recyclates from recycled PET bottles for use in accordance with the invention are preferably obtained by a method according to DE 103 24 098 A1, WO 2004/009315 A1 or according to WO 2007/116022 A2.

Preferred poly-C₁-C₆-alkylene terephthalates are also copolyesters that are prepared from at least two of the abovementioned acid components and/or from at least two of the abovementioned alcohol components. Particularly preferred copolyesters are poly(ethylene glycol/butane-1,4-diol) terephthalates.

Preferred poly-C₁-C₆-alkylene terephthalates have an intrinsic viscosity in the range from 30 to 150 cm³/g, more preferably in the range from 40 to 130 cm³/g, most preferably in the range from 50 to 100 cm³/g, in each case measured in phenol/o-dichlorobenzene (1:1 parts by weight) at 25° C. Intrinsic viscosity IV, also referred to as Staudinger Index or limiting viscosity, is proportional, according to the Mark-Houwink equation, to the average molecular mass, and is the extrapolation of the viscosity number VN for the case of vanishing polymer concentrations. It can be estimated from series of measurements or through the use of suitable approximation methods (e.g. Billmeyer). VN [ml/g] is obtained from measurement of the solution viscosity in a capillary viscometer, preferably an Ubbelohde viscometer. Solution viscosity is a measure of the average molecular weight of a plastic. The determination is effected on dissolved polymer using various solvents, preferably formic acid, m-cresol, tetrachloroethane, phenol, 1,2-dichlorobenzene, and concentrations. The viscosity number VN makes it possible to monitor the processing and performance characteristics of plastics. Thermal stress on the polymer, ageing processes or exposure to chemicals, weathering and light can be investigated by means of comparative measurements. The process is standardized for common polymers: in the context of the present invention, according to DIN ISO 1628-5 for polyesters.

The poly-C₁-C₆-alkylene terephthalates for use in accordance with the invention may also be used in a mixture with other polyesters and/or further polymers.

During compounding, the poly-C₁-C₆-alkylene terephthalates for use in accordance with the invention may be admixed with customary additives, especially mould release agents, in the melt. The person skilled in the art understands compounding as a term from plastics technology which can be equated with plastics processing and which describes the process of upgrading plastics by admixing of adjuvants (fillers, additives and so on) for targeted optimization of the profiles of properties. Compounding is preferably effected in extruders, particularly preferably in corotating twin-screw extruders, counterrotating twin-screw extruders, planetary gear extruders or co-kneaders and comprises the process operations of conveying, melting, dispersing, mixing, degassing and pressure build-up.

Preference is given to using at least one poly-C₁-C₆-alkylene terephthalate to be selected from polyethylene terephthalate [CAS No. 25038-59-9] and polybutylene terephthalate [CAS No. 24968-12-5], especially polybutylene terephthalate (PBT). Especially preferred is polybutylene terephthalate (PBT) [CAS No. 24968-12-5], available under the Pocan® brand from Lanxess Deutschland GmbH, Cologne.

Glass Fibres (Component B)

Glass fibres for use in accordance with the invention are classified as chopped fibres, also known as short fibres, having a length in the range from 0.1 to 1 mm, long fibres having a length in the range from 1 to 50 mm and continuous fibres having a length L>50 mm. Short fibres are used in injection moulding and are directly processible with an extruder. Long fibres can likewise still be processed in extruders. Said fibres are widely used in fibre spraying. Long fibres are frequently added to thermosets as a filler. Continuous fibres are used in the form of rovings or weaves in fibre-reinforced plastics. Articles of manufacture comprising continuous fibres achieve the highest stiffness and strength values. Also available are ground glass fibres, the length of these after grinding typically being in the range from 70 to 200 μm. It is also possible in accordance with the invention to use ground glass fibres.

Preference is given in accordance with the invention to using chopped long glass fibres having a starting length in the range from 1 to 50 mm, more preferably in the range from 1 to 10 mm, most preferably in the range from 2 to 7 mm. The starting length describes the average length of the glass fibres prior to compounding of the composition(s) according to the invention to afford a moulding compound according to the invention. As a result of the processing, especially compounding, to give the moulding compound or to give the article of manufacture, the glass fibres for use as component B) may have a smaller d97 or d50 value in the moulding compound or in the article of manufacture than the glass fibres originally used. Thus, the arithmetic average glass fibre length after processing is frequently still only in the range from 150 μm to 300 μm.

In the context of the present invention, glass fibre length and glass fibre length distribution in the case of processed glass fibres are determined according to ISO 22314, which first stipulates ashing of the samples at 625° C. Subsequently, the ash is placed onto a microscope slide covered with demineralized water in a suitable crystallizing dish and the ash is distributed in an ultrasound bath without action of mechanical forces. The next step comprises drying in an oven at 130° C. followed by determination of glass fibre length with the aid of optical microscopy images. For this purpose, at least 100 glass fibres are measured from three images, and so a total of 300 glass fibres are used to ascertain the length. Glass fibre length can be calculated either as the arithmetic average lₙ according to the equation

$${l}_{n} = \frac{1}{n} \cdot {\sum }_{i}^{n} {l}_{i}$$

where lᵢ=length of the ith fibre and n=number of measured fibres and suitably shown as a histogram or, assuming a normal distribution of the measured glass fibre lengths l, determined using the Gaussian function according to the equation

$$f ( l ) = \frac{1}{\sqrt{2 π} \cdot σ} \cdot {e}^{- \frac{1}{2} {( \frac{l - {l}_{c}}{σ} )}^{3}}$$

In this equation, l_{c} and σ are specific parameters of the normal distribution: l_{c} is the mean and σ is the standard deviation (see: M. Schoβig, Schädigungsmechanismen in faserverstärkten Kunststoffen [Mechanisms of damage in fibre-reinforced plastics], 1, 2011, Vieweg und Teubner Verlag, page 35, ISBN 978-3-8348-1483-8). Glass fibres not incorporated into a polymer matrix are analysed with respect to their lengths by the above methods, but without processing by ashing and separation from the ash.

Glass fibres to be used in accordance with the invention [CAS No. 65997-17-3] preferably have a fibre diameter in the range from 7 to 18 μm, more preferably in the range from 9 to 15 μm, which can be determined by at least one means available to the skilled person, in particular by computed x-ray microtomography analogously to “Quantitative Messung von Faserlängen und-verteilung in faserverstärkten Kunststoffteilen mittels μ-Röntgen-Computertomographie” [Quantitative measurement of fibre lengths and fibre distribution in fibre-reinforced plastic components by computed x-ray microtomography], J. KASTNER, et al. DGZfP annual meeting 2007—paper 47. The glass fibres for use as component B) are preferably added as continuous fibres or as chopped or ground glass fibres.

In a preferred embodiment, glass fibres to be used are modified with a suitable size system or an adhesion promoter or adhesion promoter system, more preferably based on silane.

Preferred silane-based adhesion promoters for the pretreatment of glass fibres are silane compounds of the general formula (I)

(X—(CH₂)_{q})ₖ—Si—(O—CrH₂ᵣ₊₁)₄₋ₖ (I)

in which the substituents are defined as follows:

X: NH₂—, HO—,

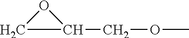

q: an integer from 2 to 10, preferably from 3 to 4,

r: an integer from 1 to 5, preferably from 1 to 2,

k: an integer from 1 to 3, preferably 1.

Especially preferred adhesion promoters are silane compounds from the group of aminopropyltrimethoxysilane, aminobutyltrimethoxysilane, aminopropyltriethoxysilane, aminobutyltriethoxysilane and the corresponding silanes comprising a glycidyl group as the substituent X.

For the modification of the glass fibres, the silane compounds are preferably used for surface coating in amounts in the range from 0.05% to 2% by weight, more preferably in the range from 0.25% to 1.5% by weight and especially in the range from 0.5% to 1% by weight, based on 100% by weight of the filler and/or reinforcer, especially the glass fibres.

Polyamide 6 (Component C)

The polyamide 6 to be used in accordance with the invention is preferably a semicrystalline polyamide, the enthalpy of fusion of which, according to DE 10 2011 084 519 A1, is in the range from 4 to 25 J/g, measured by the DSC method according to ISO 11357 in the 2nd heating run and integration of the fusion peak.

The identification of the polyamides used in the context of the present application corresponds to international standard or DIN 7728. If only one number is stated, as in the case of PA 6, this means that the starting material was an α,ω-aminocarboxylic acid or the lactam derived therefrom, i.e. ε-caprolactam in the case of PA 6; for further information, reference is made to H. Domininghaus, Die Kunststoffe and ihre Eigenschaften [Plastics and their properties], pages 272 ﬀ., VDI-Verlag, 1976.

Preference is given to using a low-viscosity polyamide 6 having a viscosity number determined in a 0.5% by weight solution in 96% by weight sulfuric acid at 25° C. according to ISO 307 in the range from 80 to 135 ml/g, more preferably in the range from 90 to 130 ml/g, even more preferably in the range from 90 to 125 ml/g, especially preferably in the range from 95 to 115 ml/g.

In a particularly preferred embodiment, a polyamide 6 having a viscosity number determined in a 0.5% by weight solution in 96% by weight sulfuric acid at 25° C. according to ISO 307 in the range from 95 to 115 ml/g is used.

Especially preferably, polyamide 6 that has been prepared by hydrolytic polymerization of ε-caprolactam is used. Polyamide 6 to be used in accordance with the invention may be sourced as Durethan® B26 from Lanxess Deutschland GmbH, Cologne.

Copolymer (Component D)

Preference is given to copolymers of at least one α-olefin with at least one methacrylic ester or acrylic ester of an aliphatic alcohol.

Particular preference is given to copolymers of one α-olefin with one methacrylic ester or acrylic ester of an aliphatic alcohol.

Very particular preference is given to copolymers of one α-olefin and one acrylic ester of an aliphatic alcohol.

Especially preferred here are copolymers in which the α-olefin is formed from ethene and the methacrylic ester or acrylic ester contains, as alcohol component, linear or branched alkyl groups having 6 to 20 carbon atoms.

Very especially preferred here are copolymers in which the α-olefin is ethene and the acrylic ester contains, as alcohol component, linear or branched alkyl groups having 6 to 20 carbon atoms.

Most especially preferably, the copolymer of at least one α-olefin and at least one acrylic ester used is a copolymer of ethene and 2-ethylhexyl acrylate or a copolymer of ethene and butyl acrylate.

Copolymers for use in accordance with the invention are notable not only for the composition but also for the low molecular weight. Accordingly, preference is given especially to copolymers having an MFI measured at 190° C. and a load of 2.16 kg of at least 100 g/10 min, preferably of at least 150 g/10 min, more preferably of at least 300 g/10 min. The MFI, melt flow index, characterizes the flow of a melt of a thermoplastic and is governed by the standards ISO 1133 or ASTM D 1238. The MFI, and all figures relating to the MFI in the context of the present invention, relate to or were measured or determined in a standard manner according to ISO 1133 at 190° C. with a test weight of 2.16 kg. Especially preferably in accordance with the invention, an ethylene-butyl acrylate copolymer available as Lotryl® 28BA700T from SK Functional Polymer is used.

Additives (Component E)

Optionally, or in a preferred embodiment, compositions, moulding compounds and articles of manufacture according to the invention contain at least one additive other than components A), B), C) and D) as component E). Preferred additives of component E) are lubricants and demoulding agents, fillers and/or reinforcers in addition to component B), UV stabilizers, colourants, chain-extending additives, plasticizers, flow promoters other than component D), heat stabilizers, antioxidants, gamma-ray stabilizers, hydrolysis stabilizers, elastomer modifiers, antistats, emulsifiers, nucleating agents, processing aids, antidrip agents and flame retardants. The additives of component E) may be used alone, or in a mixture/in the form of masterbatches. Preference is given to using, as filler and/or reinforcer in addition to component B), at least one from the group of mica, silicate, quartz, in particular quartz flour, titanium dioxide, wollastonite, nepheline syenite, kaolin, amorphous silicas, magnesium carbonate, chalk, feldspar, metal sulfates, glass fibres other than component B), glass beads, glass flour and/or fibrous fillers and/or reinforcers based on carbon fibres.

Preference is given to using particulate mineral fillers and/or reinforcers based on mica, silicate, quartz, wollastonite, kaolin, amorphous silicas, magnesium carbonate, chalk or feldspar.

Particular preference is additionally also given to using acicular mineral fillers. According to the invention, acicular mineral fillers and/or reinforcers are understood to mean a mineral filler having a very marked acicular character. The acicular mineral filler and/or reinforcer preferably has a length:diameter ratio in the range from 2:1 to 35:1, more preferably in the range from 3:1 to 19:1, most preferably in the range from 4:1 to 12:1. The median particle size d50 of the acicular minerals for use in accordance with the invention is preferably less than 20 μm, more preferably less than 15 μm, especially preferably less than 10 μm, determined with a CILAS GRANULOMETER according to ISO 13320:2009 by means of laser diffraction.

As a consequence of processing to afford the moulding compound or to afford an article of manufacture, the fillers and/or reinforcers other than component B) that are to be used optionally or in a preferred embodiment as component E) may have a smaller d97 or d50 value in said moulding compounds or articles of manufacture than the fillers and/or reinforcers and/or glass fibres originally used. They may be used individually or as a mixture of two or more different fillers and/or reinforcers.

Fillers and/or reinforcers other than component B) that are to be used as component E) may, in a preferred embodiment, be surface-modified, more preferably with an adhesion promoter or adhesion promoter system, especially preferably one based on epoxide. However, pretreatment is not absolutely necessary.

Preferably, the fillers and/or reinforcers to be used as component E) are also modified with a suitable size system or an adhesion promoter or adhesion promoter system, more preferably based on silane. Preferred silane-based adhesion promoters for the pretreatment are silane compounds of the general formula (I)

(X—(CH₂)_{q})ₖ—Si—(O—CrH₂ᵣ₊₁)₄₋ₖ (I)

in which the substituents are defined as follows:

X: NH₂—, HO—,

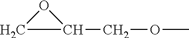

q: an integer from 2 to 10, preferably from 3 to 4,

r: an integer from 1 to 5, preferably from 1 to 2,

k: an integer from 1 to 3, preferably 1.

Especially preferred adhesion promoters are silane compounds from the group of aminopropyltrimethoxysilane, aminobutyltrimethoxysilane, aminopropyltriethoxysilane, aminobutyltriethoxysilane and the corresponding silanes comprising a glycidyl group as the substituent X.

Lubricants and demoulding agents for use as component E) are selected from at least one of the group of long-chain fatty acids, salts of long-chain fatty acids, ester derivatives of long-chain fatty acids and montan waxes.

Preferred long-chain fatty acids are stearic acid or behenic acid. Preferred salts of the long-chain fatty acids are calcium or zinc stearate. Preferred ester derivatives of long-chain fatty acids are those based on pentaerythritol, more particularly C₁₆-C₁₈ fatty acid esters of pentaerythritol [CAS No. 68604-44-4] or [CAS No. 85116-93-4].

Montan waxes in the context of the present invention are mixtures of straight-chain saturated carboxylic acids having chain lengths of from 28 to 32 carbon atoms. Particular preference is given in accordance with the invention to using lubricants and/or demoulding agents from the group of esters of saturated or unsaturated aliphatic carboxylic acids having 8 to 40 carbon atoms with aliphatic saturated alcohols having 2 to 40 carbon atoms and metal salts of saturated or unsaturated aliphatic carboxylic acids comprising 8 to 40 carbon atoms, very particular preference being given here to pentaerythritol tetrastearate, calcium stearate [CAS No. 1592-23-0] and/or ethylene glycol dimontanate, here in particular Licowax® E [CAS No. 74388-22-0] from Clariant, Muttenz, Basle, and very particular preference in particular to pentaerythritol tetrastearate [CAS No. 115-83-3], for example available as Loxiol® P861 from Emery Oleochemicals GmbH, Düsseldorf, Germany.

UV stabilizers to be used as component E) are preferably substituted resorcinols, salicylates, benzotriazoles, triazine derivatives or benzophenones.

Colourants to be used as component E) are preferably organic pigments, preferably phthalocyanines, quinacridones, perylenes and dyes, preferably nigrosin or anthraquinones, and also inorganic pigments, especially titanium dioxide (if not already used as filler), metal sulfates (if not already used as filler), ultramarine blue, iron oxide, zinc sulfide or carbon black.

Useful titanium dioxide to be used with preference as pigment in accordance with the invention includes titanium dioxide pigments, the parent oxides of which may have been produced by the sulfate (SP) or chloride (CP) process, and which have anatase and/or rutile structure, preferably rutile structure. The parent oxide does not have to be stabilized, but a specific stabilization is preferred: in the CP parent oxide by an Al doping of 0.3-3.0% by weight (calculated as Al₂O₃) and an oxygen excess in the gas phase in the oxidation of the titanium tetrachloride to form titanium dioxide of at least 2%; in the case of the SP parent oxide by doping with, for example, Al, Sb, Nb or Zn. A “light” stabilization with Al or, at higher Al doping quantities, compensation with antimony is particularly preferred. It is known that when using titanium dioxide as white pigment in paints and coatings, plastics materials etc. unwanted photocatalytic reactions caused by UV absorption lead to decomposition of the pigmented material. This involves absorption of light in the near ultraviolet range by titanium dioxide pigments, thus forming electron-hole pairs which produce highly reactive free radicals on the titanium dioxide surface. The free radicals formed result in binder decomposition in organic media. It is preferable according to the invention to reduce the photoactivity of the titanium dioxide by inorganic aftertreatment thereof, particularly preferably with oxides of Si and/or Al and/or Zr and/or through the use of Sn compounds.

It is preferable when the surface of pigmentary titanium dioxide has a covering of amorphous precipitated oxide hydrates of the compounds SiO₂ and/or Al₂O₃ and/or zirconium oxide. The Al₂O₃ shell facilitates pigment dispersion into the polymer matrix; the SiO₂ shell makes it more difficult for charge exchange to take place at the pigment surface, thus preventing polymer degradation.

According to the invention the titanium dioxide is preferably provided with hydrophilic and/or hydrophobic organic coatings, in particular with siloxanes or polyalcohols.

Titanium dioxide [CAS No. 13463-67-7] for use with preference in accordance with the invention as colourant of component E) has a median particle size d50 in the range from 90 nm to 2000 nm, more preferably in the range from 200 nm to 800 nm. The median particle size d50 is the value determined from the particle size distribution at which 50% by weight of the particles have an equivalent sphere diameter smaller than this d50 value. The relevant standard is ISO 13317-3.

The reported values for particle size distribution and median particle size for titanium dioxide are based on what are called surface area-based particle sizes, in each case before incorporation into the thermoplastic moulding compound. Particle size is determined in accordance with the invention by laser diffractometry; see C. M. Keck, Moderne Pharmazeutische Technologie [Modern Pharmaceutical Technology] 2009, Free University of Berlin, Chapter 3.1. or QUANTACHROME PARTIKELWELT NO 6, June 2007, pages 1 to 16.

Commercially available titanium dioxides include for example Kronos® 2230, Kronos® 2233, Kronos® 2225 and Kronos® vlp7000 from Kronos, Dallas, USA.

Preference is given to using the titanium dioxide for use as pigment in amounts in the range from 0.1 to 60 parts by mass, more preferably in amounts in the range from 1 to 35 parts by mass, most preferably in amounts in the range from 2 to 20 parts by mass, based in each case on 100 parts by mass of component A).

Nucleating agents for use for use as component E) are preferably sodium or calcium phenylphosphinate, aluminium oxide, silicon dioxide or talc. Particular preference is given to using talc [CAS No. 14807-96-6] as a nucleating agent, especially microcrystalline talc. Talc is a sheet silicate having the chemical composition Mg₃[Si₄O₁₀(OH)₂], which, depending on the modification, crystallizes as talc-1A in the triclinic crystal system or as talc-2M in the monoclinic crystal system. Talc for use in accordance with the invention is commercially available, for example, under the name Mistron® R10 from Imerys Talc Group, Toulouse, France (Rio Tinto Group).

It is alternatively possible with preference to use, as component E), di- or polyfunctional branching or chain-extending additives containing at least two and not more than 15 branching or chain-extending functional groups per molecule. Suitable branching or chain-extending additives include low molecular weight or oligomeric compounds which have at least two and not more than 15 branching or chain-extending functional groups per molecule, and which are able to react with primary and/or secondary amino groups, and/or amide groups and/or carboxylic acid groups. Chain-extending functional groups are preferably isocyanates, alcohols, blocked isocyanates, epoxides, maleic anhydride, oxazolines, oxazines, oxazolones, preference being given to epoxides.

Especially preferred di- or polyfunctional branching or chain-extending additives are diepoxides based on diglycidyl ethers (bisphenol and epichlorohydrin), based on amine epoxy resin (aniline and epichlorohydrin), based on diglycidyl ester (cycloaliphatic dicarboxylic acids and epichlorohydrin), separately or in mixtures, and also 2,2-bis[p-hydroxyphenyl]propane diglycidyl ether, bis[p-(N-methyl-N-2,3-epoxypropylamino)phenyl]methane and epoxidized fatty acid esters of glycerol comprising at least two and no more than 15 epoxy groups per molecule.

Particularly preferred di- or polyfunctional branching or chain-extending additives are glycidyl ethers, very particularly preferably bisphenol A diglycidyl ether [CAS No. 98460-24-3] or epoxidized fatty acid esters of glycerol, and also very particularly preferably epoxidized soya oil [CAS No. 8013-07-8].

Also particularly preferably suitable for branching/chain extension are:
1. Poly- or oligoglycidyl or poly(β-methylglycidyl) ethers, obtainable by reaction of a compound comprising at least two free alcoholic hydroxyl groups and/or phenolic hydroxyl groups and a suitably substituted epichlorohydrin under alkaline conditions, or in the presence of an acidic catalyst with subsequent alkali treatment.
Poly- or oligoglycidyl or poly(β-methylglycidyl) ethers preferably derive from acyclic alcohols, in particular ethylene glycol, diethylene glycol and higher poly(oxyethylene) glycols, propane-1,2-diol, poly(oxypropylene) glycols, propane-1,3-diol, butane-1,4-diol, poly(oxytetramethylene) glycols, pentane-1,5-diol, hexane-1,6-diol, hexane-2,4,6-triol, glycerol, 1,1,1-trimethylpropane, bistrimethylolpropane, pentaerythritol, sorbitol, or from polyepichlorohydrins.
However, said ethers also preferably derive from cycloaliphatic alcohols, in particular 1,3- or 1,4-dihydroxycyclohexane, bis(4-hydroxycyclohexyl)methane, 2,2-bis(4-hydroxycyclohexyl)propane or 1,1-bis(hydroxymethyl)cyclohex-3-ene, or they comprise aromatic nuclei, in particular N,N-bis(2-hydroxyethyl)aniline or p,p′-bis(2-hydroxyethylamino)diphenylmethane.
The epoxy compounds may preferably also derive from monocyclic phenols, in particular from resorcinol or hydroquinone; or are based on polycyclic phenols, in particular on bis(4-hydroxyphenyl)methane, 2,2-bis(4-hydroxyphenyl)propane, 2,2-bis(3,5-dibromo-4-hydroxyphenyl)propane, 4,4′-dihydroxydiphenylsulfone or on condensation products of phenols with formaldehyde obtained under acidic conditions, in particular phenol novolacs.
2. Poly- or oligo(N-glycidyl) compounds further obtainable by dehydrochlorination of the reaction products of epichlorohydrin with amines comprising at least two amino hydrogen atoms. These amines are preferably aniline, toluidine, n-butylamine, bis(4-aminophenyl)methane, m-xylylenediamine or bis(4-methylaminophenyl)methane, but also N,N,O-triglycidyl-m-aminophenyl or N,N,O-triglycidyl-p-aminophenol.

However the poly(N-glycidyl) compounds also preferably include N,N′-diglycidyl derivatives of cycloalkyleneureas, particularly preferably ethyleneurea or 1,3-propyleneurea, and N,N′-diglycidyl derivatives of hydantoins, in particular 5,5-dimethylhydantoin.
3. Poly- or oligo(S-glycidyl) compounds, in particular di-S-glycidyl derivatives deriving from dithiols, preferably ethane-1,2-dithiol or bis(4-mercaptomethylphenyl) ether.
4. Epoxidized fatty acid esters of glycerol, especially epoxidized vegetable oils. Said esters are obtained by epoxidation of the reactive olefin groups of triglycerides of unsaturated fatty acids. Epoxidized fatty acid esters of glycerol may be produced from unsaturated fatty acid esters of glycerol, preferably from vegetable oils, and organic peroxycarboxylic acids (Prilezhaev reaction). Processes for producing epoxidized vegetable oils are described, for example, in Smith, March, March's Advanced Organic Chemistry (5th edition, Wiley-Interscience, New York, 2001). Preferred epoxidized fatty acid esters of glycerol are vegetable oils. An epoxidized fatty acid ester of glycerol particularly preferred in accordance with the invention is epoxidized soybean oil [CAS No. 8013-07-8].
5. Glycidyl methacrylate-modified styrene-acrylate polymers obtainable by polymerization of styrene, glycidyl methacrylate and acrylic acid and/or methacrylic acid.

Plasticizers for use with preference as component E) are dioctyl phthalate, dibenzyl phthalate, butyl benzyl phthalate, hydrocarbon oils or N-(n-butyl)benzenesulfonamide.

Elastomer modifiers to be used with preference as component E) include one or more graft polymers of
E.1 5% to 95% by weight, preferably 30% to 90% by weight, of at least one vinyl monomer
E.2 95% to 5% by weight, preferably 70% to 10% by weight, of one or more graft bases having glass transition temperatures of <10° C., preferably <0° C., more preferably <−20° C. The percentages by weight in this case are based on 100% by weight of component E).

The graft base E.2 generally has a median particle size (d50) in the range from 0.05 to 10 μm, preferably in the range from 0.1 to 5 μm, more preferably in the range from 0.2 to 1 μm.

Monomers E.1 are preferably mixtures of
E.1.1 50% to 99% by weight of vinylaromatics and/or ring-substituted vinylaromatics, in particular styrene, α-methylstyrene, p-methylstyrene, p-chlorostyrene, and/or (C₁-C₈)-alkyl methacrylates, in particular methyl methacrylate, ethyl methacrylate, and

E.1.2 1% to 50% by weight of vinyl cyanides, in particular unsaturated nitriles such as acrylonitrile and methacrylonitrile, and/or (C₁-C₈)-alkyl (meth)acrylates, in particular methyl methacrylate, glycidyl methacrylate, n-butyl acrylate, t-butyl acrylate, and/or derivatives, in particular anhydrides and imides of unsaturated carboxylic acids, in particular maleic anhydride or N-phenylmaleimide. The percentages by weight in this case are based on 100% by weight of component E).

Preferred monomers E.1.1 are selected from at least one of the monomers styrene, α-methylstyrene and methyl methacrylate; preferred monomers E.1.2 are selected from at least one of the monomers acrylonitrile, maleic anhydride, glycidyl methacrylate and methyl methacrylate.

Particularly preferred monomers are E.1.1 styrene and E.1.2 acrylonitrile.

Graft bases E.2 suitable for the graft polymers for use in the elastomer modifiers include, for example, diene rubbers, EPDM rubbers, i.e. those based on ethylene/propylene and optionally diene, and also acrylate, polyurethane, silicone, chloroprene and ethylene/vinyl acetate rubbers. EPDM stands for ethylene-propylene-diene rubber.

Preferred graft bases E.2 are diene rubbers, especially based on butadiene, isoprene, etc., or mixtures of diene rubbers or copolymers of diene rubbers or mixtures thereof with further copolymerizable monomers, especially of E.1.1 and E.1.2, with the proviso that the glass transition temperature of component E.2 is <10° C., preferably <0° C., more preferably <−10° C.

Particularly preferred graft bases E.2 are ABS polymers (emulsion, bulk and suspension ABS), where ABS stands for acrylonitrile-butadiene-styrene, as described, for example, in DE-A 2 035 390 or in DE-A 2 248 242 or in Ullmann, Enzyklopädie der Technischen Chemie [Encyclopaedia of Industrial Chemistry], vol 19 (1980), p. 280 ﬀ.

The elastomer modifiers/graft polymers are produced by free-radical polymerization, preferably by emulsion, suspension, solution or bulk polymerization, in particular by emulsion or bulk polymerization.

Particularly suitable graft rubbers also include ABS polymers, which are produced by redox initiation with an initiator system composed of organic hydroperoxide and ascorbic acid according to US-A 4 937 285.

Since, as is well known, the graft monomers are not necessarily fully grafted onto the graft base in the grafting reaction, graft polymers are also understood in accordance with the invention to mean products that result from (co)polymerization of the graft monomers in the presence of the graft base and are also obtained in the workup.

Likewise suitable acrylate rubbers are based on graft bases E.2 that are preferably polymers of alkyl acrylates, optionally having up to 40% by weight, based on E.2, of other polymerizable, ethylenically unsaturated monomers. Preferred polymerizable acrylic esters include C₁-C₈-alkyl esters, preferably methyl, ethyl, butyl, n-octyl and 2-ethylhexyl esters; haloalkyl esters, preferably halo-C₁-C₈-alkyl esters, preferably chloroethyl acrylate, glycidyl esters, and mixtures of these monomers. Particularly preferred in this context are graft polymers having butyl acrylate as the core and methyl methacrylates as the shell, in particular Paraloid® EXL2300, Dow Corning Corporation, Midland Michigan, USA.

Further preferentially suitable graft bases as per E.2 are silicone rubbers having active grafting sites, as are described in DE-A 3 704 657, DE-A 3 704 655, DE-A 3 631 540 and DE-A 3 631 539.

Preferred graft polymers comprising a silicone proportion are those comprising methyl methacrylate or styrene-acrylonitrile as the shell and a silicone/acrylate graft as the core. Employable graft polymers having styrene-acrylonitrile as the shell include Metablen® SRK200 for example. Employable graft polymers having methyl methacrylate as the shell include Metablen® S2001, Metablen® S2030 and/or Metablen® SX-005, for example. Particular preference is given to using Metablen® S2001. The products having the Metablen® trade name are available from Mitsubishi Rayon Co., Ltd., Tokyo, Japan.

Crosslinking may be achieved by copolymerizing monomers having more than one polymerizable double bond. Preferred examples of crosslinking monomers are esters of unsaturated monocarboxylic acids having 3 to 8 carbon atoms and unsaturated monohydric alcohols having 3 to 12 carbon atoms or of saturated polyols having 2 to 4 OH groups and 2 to 20 carbon atoms, preferably ethylene glycol dimethacrylate, allyl methacrylate; polyunsaturated heterocyclic compounds, preferably trivinyl cyanurate and triallyl cyanurate; polyfunctional vinyl compounds, preferably di- and trivinylbenzenes; but also triallyl phosphate and diallyl phthalate.

Preferred crosslinking monomers are allyl methacrylate, ethylene glycol dimethacrylate, diallyl phthalate and heterocyclic compounds having at least 3 ethylenically unsaturated groups.

Particularly preferred crosslinking monomers are the cyclic monomers triallyl cyanurate, triallyl isocyanurate, triacryloylhexahydro-s-triazine, triallylbenzenes. The amount of the crosslinked monomers is preferably 0.02% to 5% by weight, in particular 0.05% to 2% by weight, based on 100% by weight of the graft base E.2.

In the case of cyclic crosslinking monomers having at least 3 ethylenically unsaturated groups, it is advantageous to restrict the amount to below 1% by weight, based on 100% by weight of the graft base E.2.

Preferred “other” polymerizable, ethylenically unsaturated monomers which, in addition to the acrylic esters, may optionally be used to produce the graft base E.2 are acrylonitrile, styrene, α-methylstyrene, acrylamides, vinyl C₁-C₆-alkyl ethers, methyl methacrylate, glycidyl methacrylate, butadiene. Preferred acrylate rubbers as graft base E.2 are emulsion polymers having a gel content of at least 60% by weight.

In addition to elastomer modifiers based on graft polymers, it is likewise possible to use elastomer modifiers which are not based on graft polymers and which have glass transition temperatures of <10° C., preferably <0° C., more preferably <−20° C. These preferably include elastomers having a block copolymer structure and in addition thermoplastically meltable elastomers, especially EPM, EPDM and/or SEBS rubbers (EPM=ethylene-propylene copolymer, EPDM=ethylene-propylene-diene rubber and SEBS=styrene-ethene-butene-styrene copolymer).

Preferred flame retardants to be used as component E) are halogen-free.

The phosphorus-containing flame retardants for use with preference as component E) include, for example, phosphorus-containing compounds from the group of the organic metal phosphinates, especially metal diethylphosphinates, the inorganic metal phosphinates, especially aluminium phosphinate and zinc phosphinate, the mono- and oligomeric phosphoric and phosphonic esters, especially triphenyl phosphate (TPP), resorcinol bis(diphenylphosphate) (RDP), bisphenol A bis(diphenylphosphate) (BDP) including oligomers, polyphosphonates, especially bisphenol A-diphenyl methylphosphonate copolymers, for example Nofia™ HM1100 [CAS No. 68664-06-2] from FRX Polymers, Chelmsford, USA), and also derivatives of the 9,10-dihydro-9-oxa-10-phosphaphenanthrene 10-oxides (DOPO derivatives), phosphonate amines, metal phosphonates, especially aluminium phosphonate and aluminium alkylphosphonates, and zinc phosphonate and zinc alkylphosphonates, and also phosphine oxides and phosphazenes. Particularly preferred phosphazenes are phenoxyphosphazene oligomers. Further phosphorus-containing flame retardants for use with preference as component E) are melamine pyrophosphate, melamine polyphosphate, melamine poly(aluminium phosphate), melamine poly(zinc phosphate), and reaction products of melem, melam, melon with condensed phosphoric acids.

It is likewise possible to use phosphorus-free nitrogen-containing flame retardants, individually or in a mixture, as further flame retardants of component E). Preferred nitrogen-containing flame retardants are the reaction products of trichlorotriazine, piperazine and morpholine of CAS No. 1078142-02-5, especially MCA PPM Triazine HF from MCA Technologies GmbH, Biel-Benken, Switzerland, and also melamine cyanurate and condensation products of melamine, especially melem, melam, melon or more highly condensed compounds of this type. Preferred inorganic nitrogen-containing compounds are ammonium salts.

It is also possible to use other flame retardants or flame retardant synergists that are not specifically mentioned here as component E). These also include purely inorganic phosphorus compounds, in particular red phosphorus or boron phosphate hydrate. It is also possible to use mineral flame retardant additives, for example magnesium hydroxide or salts of aliphatic and aromatic sulfonic acids, in particular metal salts of 1-perfluorobutanesulfonic acid. Also suitable are flame retardant synergists from the group of the oxygen-, nitrogen- or sulfur-containing metal compounds in which metal is antimony, zinc, molybdenum, calcium, titanium, magnesium or boron, preferably antimony trioxide, antimony pentoxide, sodium antimonate, zinc oxide, zinc borate, zinc stannate, zinc hydroxystannate, zinc sulfide, molybdenum oxide, and, if not already used as colourant, titanium dioxide, magnesium carbonate, calcium carbonate, calcium oxide, titanium nitride, boron nitride, magnesium nitride, zinc nitride, calcium borate, magnesium borate or mixtures thereof.

Further flame retardant additives that are suitable and are preferred for use as component E) are char formers, more preferably poly(2,6-diphenyl-1,4-phenyl) ether, especially poly(2,6-dimethyl-1,4-phenylene) ether [CAS No. 25134-01-4], phenol-formaldehyde resins, polycarbonates, polyimides, polysulfones, polyethersulfones or polyether ketones, and also antidrip agents, especially tetrafluoroethylene polymers. The tetrafluoroethylene polymers may be used in pure form or else in combination with other resins, preferably styrene-acrylonitrile (SAN), or acrylates, preferably methyl methacrylate/butyl acrylate.

If required for the application, halogen-containing flame retardants may also be used. These include commercially available organic halogen compounds with or without synergists. Halogenated, in particular brominated and chlorinated, compounds preferably include ethylene-1,2-bistetrabromophthalimide, decabromodiphenylethane, tetrabromobisphenol A epoxy oligomer, tetrabromobisphenol A oligocarbonate, tetrachlorobisphenol A oligocarbonate, polypentabromobenzyl acrylate, brominated polystyrene and brominated polyphenylene ethers.

The flame retardants for additional use as component E) can be added to the polyalkylene terephthalate or polycycloalkylene terephthalate in pure form, and also via masterbatches or compacted preparations.

Heat stabilizers preferred for use as component E) are selected from the group of sulfur-containing stabilizers, especially sulfides, dialkylthiocarbamates or thiodipropionic acids, and also those selected from the group of the iron salts and the copper salts, in the latter case especially copper(I) iodide, being used preferably in combination with potassium iodide and/or sodium hypophosphite NaH₂PO₂, and also sterically hindered amines, especially tetramethylpiperidine derivatives, aromatic secondary amines, especially diphenylamines, hydroquinones, substituted resorcinols, salicylates, benzotriazoles and benzophenones, and also sterically hindered phenols and aliphatically or aromatically substituted phosphites, and also differently substituted representatives of these groups.

Among the sterically hindered phenols, preference is given to using those having at least one 3-tert-butyl-4-hydroxy-5-methylphenyl unit and/or at least one 3,5-di(tert-butyl-4-hydroxyphenyl) unit, particular preference being given to hexane-1,6-diol bis[3-(3,5-di-tert-butyl-4-hydroxyphenyl)propionate] [CAS No. 35074-77-2] (Irganox® 259 from BASF SE, Ludwigshafen, Germany), pentaerythritol tetrakis[3-(3,5-di-tert-butyl-4-hydroxyphenyl)propionate] [CAS No. 6683-19-8] (Irganox® 1010 from BASF SE) and 3,9-bis[2-[3-(3-tert-butyl-4-hydroxy-5-methylphenyl)propionyloxy]-1,1-dimethylethyl]-2,4,8,10-tetraoxaspiro[5.5]undecanes [CAS No. 90498-90-1] (ADK Stab® AO 80). ADK Stab® AO 80 is commercially available from Adeka-Palmerole SAS, Mulhouse, France.

Among the aliphatically or aromatically substituted phosphites, preference is given to using bis(2,4-dicumylphenyl)pentaerythritol diphosphite [CAS No. 154862-43-8], which is available for example from Dover Chemical Corp., Dover, USA under the trade name Doverphos® S9228, and tetrakis(2,4-di-tert-butylphenyl)-1,1-biphenyl-4,4′-diyl bisphosphonite [CAS No. 38613-77-3], which is obtainable, for example, as Hostanox® P-EPQ from Clariant International Ltd., Muttenz, Switzerland.

Especially Preferred Uses

The invention more preferably relates to the use of polyamide 6 for reduction of the melt viscosity, to be determined at 260° C. to ISO 11443, and/or of the fill pressure, to be determined according to EN ISO 294-1, of compositions and moulding compounds in which there are 10 to 115 parts by mass of glass fibres and 0.5 to 30 parts by mass of ethylene-butyl acrylate copolymer per 100 parts by mass of polybutylene terephthalate.

The invention more particularly relates to the use of 0.5 to 15 parts by mass of polyamide 6 for reduction of the melt viscosity, to be determined at 260° C. to ISO 11443, and/or of the fill pressure, to be determined according to EN ISO 294-1, of compositions and moulding compounds in which there are 10 to 115 parts by mass of glass fibres and 0.5 to 30 parts by mass of ethylene-butyl acrylate copolymer per 100 parts by mass of polybutylene terephthalate.

Especially Preferred Methods

The invention more preferably relates to a method of reducing the melt viscosity, to be determined at 260° C. to ISO 11443, and/or of the fill pressure, to be determined according to EN ISO 294-1, of compositions and moulding compounds in which there are 10 to 115 parts by mass of glass fibres and 0.5 to 30 parts by mass of ethylene-butyl acrylate copolymer per 100 parts by mass of polybutylene terephthalate by adding polyamide 6, preferably polyamide 6 in amounts in the range of 0.5 to 15 parts by mass.

Especially Preferred Compositions, Moulding Compounds and Articles of Manufacture

In a preferred embodiment, the present invention additionally relates to compositions, moulding compounds and articles of manufacture comprising, per A) 100 parts by mass of polybutylene terephthalate, B) 10 to 115 parts by mass of glass fibres, C) 0.5 to 15 parts by mass of polyamide 6 and D) 0.5 to 30 parts by mass of ethylene-butyl acrylate copolymer.

Preferred articles of manufacture are articles of manufacture for the electrical or electronics industry, more preferably articles of manufacture for electromobility.

Moulding compounds of the invention are formulated for further use, especially by injection moulding or by extrusion, by mixing the components to be used in at least one mixing apparatus, preferably compounder. This affords, as intermediates, moulding compounds based on the compositions of the invention. The moulding compounds are ultimately used to produce articles of manufacture by suitable methods.

The present invention alternatively relates to a process for producing articles of manufacture, preferably for the electrical industry, electromobility or the electronics industry, more preferably electronic or electric assemblies and components, by mixing compositions according to the invention to give a moulding compound, discharging it in the form of an extrudate, cooling the extrudate until it is pelletizable and pelletizing it, and finally subjecting the pelletized material in the form of a matrix material to an injection moulding or extrusion operation, preferably an injection moulding operation. In one embodiment, the moulding compound can be sent directly to the injection moulding or an extrusion without discharging it to form an extrudate and pelletizing it.

Mixing is preferably performed at temperatures in the range from 240 to 310° C., preferably in the range from 260 to 300° C., particularly preferably in the range from 270 to 295° C., in the melt. Especially preferably, a twin-shaft extruder is used for this purpose.

In one embodiment, the pellet material comprising the composition according to the invention is dried, preferably at temperatures in the range around 120° C. in a vacuum drying cabinet or in a dry air drier, for a duration in the region of 2 hours, before being subjected as matrix material to injection moulding or an extrusion process in order to produce articles of manufacture according to the invention.

The methods of injection moulding and of extrusion of thermoplastic moulding compounds are known to those skilled in the art. Methods according to the invention for producing polyester-based articles of manufacture by extrusion or injection moulding operate at melt temperatures in the range from 240° C. to 330° C., preferably in the range from 260° C. to 300° C., particularly preferably in the range from 270° C. to 290° C., and optionally, in addition, at pressures of not more than 2500 bar, preferably at pressures of not more than 2000 bar, particularly preferably at pressures of not more than 1500 bar and very particularly preferably at pressures of not more than 750 bar.

Sequential coextrusion involves extruding two different materials successively in an alternating sequence. This forms a preform having a material composition that differs section by section in the extrusion direction. It is possible to endow particular article sections with specifically required properties through appropriate material selection, for example for articles with soft ends and a hard middle section or integrated soft bellows regions (Thielen, Hartwig, Gust, “Blasformen von Kunststoffhohlkörpern” [Blow-Moulding of Hollow Plastics Bodies], Carl Hanser Verlag, Munich 2006, pages 127-129).

In injection moulding, a moulding compound comprising the compositions according to the invention, preferably in pellet form, is melted in a heated cylindrical cavity (i.e. plastified) and injected under pressure into a heated cavity as the injection material. After the cooling (solidification) of the material, the injection moulding is demoulded.

The following are distinguished:
1. plastification/melting
2. injection phase (filling operation)
3. hold pressure phase (because of thermal contraction during crystallization)
4. demoulding.

An injection moulding machine comprises a closure unit, the injection unit, the drive and the control system. The closure unit includes fixed and movable platens for the mould, an end platen, and tie bars and drive for the movable mould platen (toggle joint or hydraulic closure unit).

An injection unit comprises the electrically heatable barrel, the drive for the screw (motor, transmission) and the hydraulics for moving the screw and the injection unit. The injection unit serves to melt, meter, inject and exert hold pressure (because of contraction) on the powder/the pelletized material. The problem of melt backflow inside the screw (leakage flow) is solved by nonreturn valves.

In the injection mould, the incoming melt is then separated and cooled and the article of manufacture to be fabricated is thus fabricated. Two halves of the mould are always needed for this purpose. In injection moulding, the following functional systems are distinguished:
runner system
shaping inserts
venting
machine mounting and force absorption
demoulding system and movement transmission
temperature control

In contrast to injection moulding, extrusion involves using an endless plastics extrudate of a moulding compound according to the invention in the extruder, the extruder being a machine for producing shaped thermoplastic mouldings. A distinction is made between single-screw extruders and twin-screw extruders, and also between the respective subgroups of conventional single-screw extruders, conveying single-screw extruders, contrarotating twin-screw extruders and corotating twin-screw extruders.

Extrusion systems are composed of the following elements: extruder, mould, downstream equipment, extrusion blow moulds. Extrusion systems for producing profiles are composed of the following elements: extruder, profile mould, calibrating unit, cooling zone, caterpillar take-off and roller take-off, separating device and tilting chute.

The present invention consequently also relates to halogen-free articles of manufacture, especially to leakage current-resistant, halogen-free articles of manufacture, obtainable by extrusion, preferably profile extrusion, or injection moulding of the moulding compounds obtainable from the compositions according to the invention.

It will be understood that the specification and examples are illustrative but not limitative of the present invention and that other embodiments within the spirit and scope of the invention will suggest themselves to those skilled in the art.

### EXAMPLES

In order to demonstrate the improvements described in accordance with the invention with regard to melt viscosity and/or fill pressure, corresponding moulding compounds were first made up by compounding. To this end, the individual components were mixed in a twin-screw extruder (ZSK 26 Mega Compounder from Coperion Werner & Pfleiderer (Stuttgart, Germany)) at temperatures in the range from 260 to 290° C., discharged in the form of an extrudate, cooled until pelletizable and pelletized. After drying (generally 2 h at 120° C. in a vacuum drying cabinet), the pellets were processed to form test specimens.

The test specimens for the investigations reported in Tab. 1 were injection-moulded on an Arburg 320-210-500 injection moulding machine at a melt temperature of 260° C. and a mould temperature of 80° C.

Reactants:

Component A): Linear polybutylene terephthalate (Pocan® B 1300, commercial product from Lanxess Deutschland GmbH, Leverkusen, Germany) having an intrinsic viscosity of 93 cm³/g (measured in phenol:1,2-dichlorobenzene=1:1 at 25° C.)

Component B): Glass fibres (CS 7967 (26/1493) D, commercial product from Lanxess Deutschland GmbH, Leverkusen, Germany)

Component C): Polyamide 6 (Durethan® B26, commercial product from Lanxess Deutschland GmbH, Leverkusen, Germany)

Component D): Ethylene-butyl acrylate copolymer (Lotryl® 28BA700T, SK Functional Polymer)

Component(s) E):

E1) nucleating agent: talc

E2) thermal stabilizer: additive DP0001 [CAS No. 649560-74-7], Lanxess Deutschland GmbH

TABLE 1

| | | | Comp. 2, ex. | | | | | |
|---|---|---|---|---|---|---|---|---|
| | | | as per WO | | | | | |
| | | Comp. 1 | 2005/121245A1 | Ex. 1 | Comp. 3 | Ex. 2 | Comp. 4 | Ex. 3 |
| Component A) | [parts by mass] | 100 | 100 | 100 | 100 | 100 | 100 | 100 |
| Component B) | [parts by mass] | 27.5 | 27.5 | 27.5 | 12 | 12 | 48 | 48 |
| Component C) | [parts by mass] | | | 3 | | 2 | | 3 |
| Component D) | [parts by mass] | | 8 | 8 | 5 | 5 | 9.5 | 9.5 |
| Component E1) | [parts by mass] | 0.1 | 0.1 | 0.1 | 0.1 | 0.1 | 0.2 | 0.2 |
| Component E2) | [parts by mass] | 0.1 | 0.1 | 0.1 | 0.1 | 0.1 | 0.2 | 0.2 |
| Fill pressure for | [bar] | 192 | 123 | 105 | 153 | 134 | 156 | 125 |
| dumbbell specimen | | | | | | | | |
| Melt viscosity | [Pas] | 157 | 94 | 81 | 117 | 105 | 113 | 106 |
| (260° C., 1000 s⁻¹) | | | | | | | | |
| CTI | [V] | 325 | 425 | 525 | 375 | 600 | 475 | 500 |
| Heat distortion | [° C.] | 202 | 199 | 205 | 175 | 182 | 205 | 207 |
| resistance | | | | | | | | |
| Tensile modulus | [MPa] | 7015 | 6530 | 6595 | 4354 | 4510 | 9095 | 9627 |
| Tensile strength | [MPa] | 118 | 105 | 103 | 83 | 81 | 123 | 124 |
| Elongation at break | [%] | 3.9 | 3.4 | 3.4 | 4.5 | 4.2 | 3 | 3 |

In order to determine the fill pressure as defined in EN ISO 294-1, a dumbbell specimen having a geometry according to ISO 527-2/type 1A was injection-moulded, and the pressure required in the injection moulding machine was recorded. The melt temperature was set to 260° C. and the mould temperature to 80° C.

Melt viscosity was determined at 260° C. to ISO 11443 at the shear rate specified.

Heat distortion resistance was determined on 80 mm×10 mm×4 mm test specimens to ISO 75-2 Method A (flexural stress of 1.80 MPa).

Tensile modulus, tensile strength and elongation at break were measured to ISO 527.

Tracking resistance is described by the CTI (comparative tracking index) and was determined by the method described in standard ISO 60112:2003. The surface of the test specimen (60 mm×40 mm×4 mm) was subjected to an electrical voltage using two electrodes, while the surface was treated between the electrodes with droplets of an electrolyte solution that simulated dust and moisture. The CTI is the highest voltage where there was no failure (short-circuit or ignition) after 50 droplets.

Tab. 1 shows, especially in the comparison of ex. 1 with comp. 2, an example according to WO 2005/121245A1, that addition of polyamide 6 gave another distinct reduction both in melt viscosity and in fill pressure.

What is claimed is:

1. A method for reduction of the melt viscosity to be determined at 260° C. to ISO 11443, and/or of the fill pressure to be determined according to EN ISO 294-1, of compositions and moulding compounds having 10 to 115 parts by mass of glass fibers per 100 parts by mass of poly-C₁-C₆-alkylene terephthalate, comprising including polyamide 6 in the compositions and moulding compounds.

2. A method according to claim 1, wherein the poly-C₁-C₆-alkylene terephthalate is polyethylene terephthalate.

3. A method according to claim 1, wherein the poly-C₁-C₆-alkylene terephthalate is polybutylene terephthalate.

4. A method according to claim 1, wherein in addition to the glass fibers 0.5 to 30 parts by mass of at least one copolymer of at least one α-olefin and at least one methacrylic ester or acrylic ester of an aliphatic alcohol are applied.

5. A method according to claim 4, wherein the copolymer of at least one α-olefin and at least one acrylic ester used is a copolymer of ethene and 2-ethylhexyl acrylate.

6. A method according to claim 4, wherein the copolymer of at least one α-olefin and at least one acrylic ester used is a copolymer of ethene and butyl acrylate.

7. A method according to claim 1, wherein the amount of polyamide 6 used is 0.5 to 15 parts by mass.

8. A method according to claim 1, wherein the compositions and moulding compounds are the basis for components to be used in the electrical or electronics industry.

9. A method according to claim 1, wherein the compositions and moulding compounds are the basis for components to be used in the electromobility.

10. Compositions, moulding compounds and articles of manufacture comprising, per
A) 100 parts by mass of poly-C1-C6-alkylene terephthalate,
B) 10 to 115 parts by mass of glass fibres,
C) 0.5 to 15 parts by mass of polyamide 6, and
D) 0.5 to 30 parts by mass of at least one copolymer of at least one α-olefin and at least one methacrylic ester or acrylic ester of an aliphatic alcohol.

11. Compositions, moulding compounds and articles of manufacture according to claim 10, wherein the poly-C₁-C₆-alkylene terephthalate is polyethylene terephthalate.

12. Compositions, moulding compounds and articles of manufacture according to claim 10, wherein the poly-C₁-C₆-alkylene terephthalate is polybutylene terephthalate.

13. Compositions, moulding compounds and articles of manufacture according to claim 10, wherein the copolymer of at least one α-olefin and at least one acrylic ester used is a copolymer of ethene and 2-ethylhexyl acrylate.

14. Compositions, moulding compounds and articles of manufacture according to claim 10, wherein the copolymer of at least one α-olefin and at least one acrylic ester used is a copolymer of ethene and butyl acrylate.
